(19) United States
(12) Patent Application Publication
(10) Pub. No.: US 2018/0290894 A1
(43) Pub. Date: Oct. 11, 2018

(54) PROCESS FOR REMOVAL OF BROMINE, IODINE, BROMINE- AND/OR IODINE-CONTAINING COMPOUNDS FROM CHLOROSILANES

(71) Applicant: Evonik Degussa GmbH, Essen (DE)

(72) Inventors: Jürgen Erwin Lang, Karlsruhe (DE); Hartwing Rauleder, Rheinfelden (DE)

(73) Assignee: Evonik Degussa GmbH, Essen (DE)

(21) Appl. No.: 15/945,415

(22) Filed: Apr. 4, 2018

(30) Foreign Application Priority Data
Apr. 5, 2017 (EP) 17165034.4

(51) Int. Cl. C01B 33/107; B01D 5/00; B01D 3/10; B01J 19/08

(52) U.S. Cl. CPC C01B 33/10778; C01B 33/1071; B01D 5/006; B01D 3/10; B01J 2219/0896; B01D 2257/2022; B01D 2259/818; B01J 2219/00162; B01J 2219/0875; B01J 19/08

(57) ABSTRACT

The invention relates to a process for removal of bromine, bromine- and/or iodine-containing silicon compounds from compositions of chlorosilanes containing bromine, bromine- and/or iodine-containing silicon compounds, wherein the composition is subjected to a nonthermal plasma and subsequently the chlorosilanes may be separated from the bromine- and/or iodine-containing compounds present by distillation.

### CROSS REFERENCE TO RELATED APPLICATIONS

This application claims foreign priority to EP 17165034.4, filed on Apr. 5, 2017, the entire text of which is incorporated herein by reference.

The invention relates to a process for removal of bromine, iodine, bromine- and/or iodine-containing compounds from compositions of chlorosilanes containing bromine, iodine, bromine- and/or iodine-containing compounds, wherein the composition is subjected to a nonthermal plasma and subsequently the chlorosilanes may be separated from the bromine- and/or iodine-containing compounds present by distillation.

Chlorosilanes which are employed in microelectronics, for example for producing high-purity silicon by epitaxy or silicon nitride (SiN), silicon oxide (SiO), silicon oxynitride (SiON), silicon oxycarbide (SiOC) or silicon carbide (SiC), must satisfy particularly high demands in respect of their purity. This applies particularly to the production of thin layers of these materials. In the recited fields of application impurities of the starting compounds even in the ppb to ppt range are disruptive. Chlorosilanes, in particular high-purity chlorosilanes, form an important product class in many fields of application, such as the semiconductor industry or fibre optics industry. Contaminations of the chlorosilanes with other halogens or other halogen compounds, for example bromine and/or bromine-containing compounds, have proven particularly adverse. Such contaminations, even in the lower ppm range and even down to the ppb range, may be extremely disruptive in the industrial chlorosilane applications.

By way of example tetrachlorosilane and hexachlorodisilane in the required purity are sought-after starting compounds in the field of electronics, in the semiconductor industry and also in the pharmaceuticals industry.

To produce the recited high-purity compounds silicon nitride, silicon oxide, silicon oxynitride, silicon oxycarbide or silicon carbide, in particular layers of these compounds, tetrachlorosilane and hexachlorodisilane are converted by reaction with further nitrogen- , oxygen- or carbon-containing precursors. Also for the production of epitaxial silicon layers, by means of low-temperature epitaxy, tetrachlorosilane or hexachlorodisilane are used.

The present invention has for its object to develop a process allowing reliable and preferably continuous removal of bromine, iodine, bromine- and/or iodine-containing compounds. One problem was that the bromine- and/or iodine-containing compounds can have similar boiling points to the chlorosilanes and a distillative removal is therefore not possible. Furthermore very low contents of these impurities are not achievable using distillation as the sole purification method.

### BRIEF DESCRIPTION OF THE DRAWINGS

The Figure shows a FT-IR spectrum with BrCl₂SiH before a plasma treatment and after the plasma treatment and redistillation.

The object is achieved by the process according to the invention as per the features of claim 1 and by the use according to claim 13.

It has now been found that, surprisingly, this object can be achieved when a chlorosilane mass flow containing the abovementioned impurities comprising bromine and/or iodine is treated using a nonthermal plasma synonymous with cold plasma. The chlorosilane mass flow which preferably contains SiCl₄ and the impurities comprising other halogens or other halogen compounds, for example bromine and/or bromine-containing compounds, is supplied in a plasma discharge apparatus, preferably an ozonizer, and therein reacted in the cold plasma.

The treatment according to the invention in the nonthermal plasma subjects the chlorosilane mass flow to a treatment to make it amenable to a distillative purification and removal of the other halogen compounds, such as bromine and iodine. The effect of the plasma treatment is thought to be a favoring of the kinetics to effect plasmachemical formation of chlorine radicals which selectively substitute bromine and iodine at the relevant halogen compounds, thus resulting in a boiling point alteration of the compounds which makes the mass flow amenable to a distillative workup.

The present invention provides a process for removal of other halogens or other halogen compounds, bromine- or iodine-containing silicon compounds of general formula III, in particular of HSiCl₂Br and/or HSiClBr₂,

from compositions of chlorosilanes, wherein the chlorosilanes comprise
at least one chlorosilane of general formula I,

SiCl₄ (I),
polyperchlorosilanes of general formula II

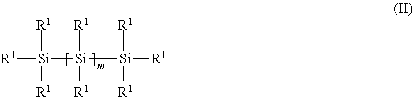

where R¹ is in each case chlorine and where m =0, 1, 2, 3, 4 to 100,
branched polyperchlorosilanes and/or cyclic polyperchlorosilanes and/or mixtures of the aforementioned chlorosilanes,

wherein

(i) the composition of chlorosilanes is converted into the gaseous state
and

(ii) subjected to a plasma, in particular a nonthermal plasma, and
a converted composition of chlorosilanes is obtained,

(iii) distilling the converted composition of chlorosilanes and

(iv) obtaining a composition of chlorosilanes having a reduced content of bromine, bromine- and/or
iodine-containing silicon compounds,
wherein
the silicon tetrachloride of general formula I where n=0 and/or hexadichlorosilane of formula II where n=0 is subjected to a nonthermal plasma,
and the bromine- and/or iodine-containing silicon compounds are halosilanes of general formula Ill

SiHal₄₋ₙHₙ (III),
wherein at least one Hal is selected from bromine and iodine and further Hal is independently selected from iodine where n=0, 1, 2 or 3.

Surprisingly, compositions of chlorosilanes having a reduced content of bromine, bromine- and/or iodine-containing silicon compounds can be obtained. These compositions have a purity and also highest purity of isolable chloro compounds. A composition comprising chlorosilanes has a high purity when impurities are only in the ppb region; highest purity is to be understood as meaning impurities having a content of not more than 0.05 ppmw.

Preferably the composition in process step (iv) has a content of not more than 1 ppmw of bromine, bromine- and/or iodine-containing silicon compounds, in particular the content of bromine is not more than 1 ppmw. It is preferable when the content of bromine, bromine- and/or iodine-containing silicon compounds is not more than 0.5 ppmw, preferably not more than 0.11 ppmw, particularly preferably not more than 0.05 ppmw, wherein a content of bromine of not more than 0.05 ppmw is particularly preferable.

The compositions produced by the process according to the invention comprising chlorosilanes are suitable for use in the semiconductor industry or pharmaceuticals industry.

In process step (ii) the obtained converted composition of chlorosilanes is preferably condensed after one or more passes through the nonthermal plasma. The thus obtained liquid converted composition of chlorosilanes may subsequently be distilled to remove the chlorosilanes from the bromine, bromine- and/or iodine-containing silicon compounds.

The compositions of the chlorosilanes for use in the process may contain as bromine- and/or iodine-containing silicon compounds for example halosilanes of general formula III, where SiHal₄₋ₙHₙ (III), wherein at least one Hal is selected from bromine and iodine and optionally further Hal are each independently selected from chlorine, bromine and iodine where n=0, 1, 2 or 3. By way of example the bromine- and/or iodine-containing silicon compound may be selected from the halosilanes of general formula Ill HSiCl₂Br or HSiClBr₂; it is preferably HSiCl₂Br.

The bromine- and/or iodine-containing silicon compounds may likewise be linear, branched and/or cyclic polyhalosilanes, such as linear polyhalosilanes of formula III where R² are each independently selected from halogen comprising chlorine, bromine and iodine and hydrogen, wherein R² represents identical or different radicals, wherein at least one R² is a halogen and where y=0, 1, 2, 3, 4 to 100, in particular y=0, 1, 2, 3, 4, 5, 6 to 10.

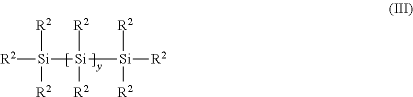

In respect of the converted bromine- and/or iodine-containing silicon compounds in process step (iii) it is preferable when these accumulate in a collection vessel of an apparatus for performing the process. A corresponding enrichment is possible since by substitution of hydrogen by a chlorine atom or else substitution of bromine by chlorine or iodine by chlorine or else the formation of dimers compounds with altered boiling points are formed.

The bromine- and/or iodine-containing silicon compounds comprise bromine-containing silanes, iodine-containing silanes, bromine- and iodine-containing silanes and/or mixtures comprising at least two of the aforementioned compounds.

The process step (ii), the nonthermal plasma treatment, is preferably effected at pressures of 1 to 1000 mbar_{abs}., preferably of 100 to 800 mbar_{abs}., particularly preferably of 100 to 500 mbar_{abs}.

In a preferred embodiment the process steps (ii) and optionally (iii) may be effected continuously.

In a preferred embodiment as the chlorosilane of general formula I silicon tetrachloride where n=0 is subjected to a nonthermal plasma. In a further preferred embodiment hexadichlorosilane of formula II where n=0 may be subjected to a nonthermal plasma.

In process step (iii) the distillative workup may be effected at a pressure between 1 to 1500 mbar_{abs}, a pressure of 100 to 1000 mbar_{abs} is preferred, particularly preferably of 100 to 500 mbar_{abs.}. Also effected in process step (iii) is the distillative workup of the converted composition at tops temperatures in the range from 40° C. to 250° C., preferably from 50° C. to 150° C., particularly preferably from 50° C. to 100° C.

The ozonizer is preferably operated as a closed-loop reactor. The pure product is preferably withdrawn from the process. In addition to bromine, iodine and bromine- and iodine-containing compounds, N₂ is also removed. The residual gas which contains the HCl is recycled.

For the known principles of gas discharge and plasma chemistry, reference is made to the relevant technical literature: for example A. T. Bell “Fundamentals of Plasma Chemistry” ed. J. R. Hollahan and A. T. Bell, Wiley, New York (1974).

The nonthermal plasma preferably has a power density of 0.1 to 50 W/cm³, in particular of 1 to 20 W/cm³, preferably 2 to 15 W/cm³, more preferably around 10 W/cm³ plus/minus 2.5 W/cm³. The generation of the nonthermal plasma is generally effected in a tubular reactor, in particular in a glass tubular reactor, preferably in a fused quartz tubular reactor.

The invention likewise provides for the use of a nonthermal plasma for removal of bromine, bromine- and/or iodine-containing compounds, in particular of bromine- and/or iodine-containing silicon compounds, from compositions of chlorosilanes.

Unconverted bromine, iodine, bromine- and/or iodine-containing silicon compounds are resent to the nonthermal plasma as required. For complete conversion of the compounds a cycle mode having 1 to 100 cycles may be utilized; a small number of 1 to 5 cycles is preferred; preferably only one cycle is performed.

The nonthermal plasma is generated in a plasma reactor in which a plasma-electrical conversion of matter is induced and is based on anisothermal plasmas. For these plasmas, a high electron temperature Tₑ≥10⁴ K and relatively low gas temperature T_{G}≤10³ K are characteristic. The activation energy required for the chemical processes is effected predominantly via electron collisions (plasma-electrical conversion of matter). Typical nonthermal plasmas can be generated, for example, by glow discharge, HF discharge, hollow cathode discharge or corona discharge. The operating pressure at which the plasma treatment according to the invention is performed is between 1 to 1000 mbar_{abs}, preferably at 1 to 800 mbar_{abs}, particularly preferably at 100 to 500 mbar_{abs}, in particular at 200 to 500 mbar_{abs}, wherein the phase to be treated is preferably adjusted to a temperature of −40° C. to 200° C., particularly preferably of 20° C. to 80° C., very particularly preferably to 40° C. to 60° C. In the case of germanium compounds the relevant temperature may also be higher.

For the definition of the nonthermal plasma and of homogeneous plasma catalysis, reference is made to the relevant technical literature, for example to “Plasmatechnik: Grundlagen and Anwendungen—Eine Einfuhrung” [Plasma technology: Fundamentals and Applications—An Introduction]; team of authors, Carl Hanser Verlag, Munich/Vienna; 1984, ISBN 3-446-13627-4.

According to the invention the workup may be effected continuously in a column system comprising at least one column, preferably in a system comprising at least two columns. In this way for example the hydrogen chloride gas (HCl) likewise formed in the reaction may be removed overhead via a so-called low boilers column, first column, and the mixture collected from the bottom may be fractionated into its constituents when silicon tetrachloride (SiCl₄) is removed by distillation at the top of a second column and higher boilers, for example hexachlorodisilane (Si₂Cl₆), are removed by distillation at the top of a third column; a fourth column may optionally be connected for removal of the octachlorotrisilane. In this way the reaction mixture obtained from the plasma reactor may be fractionated further by rectification.

The apparatus may further employ, in addition to the reactor, one or more further reactors connected in series or in parallel. According to the invention, at least one reactor in the apparatus is an ozonizer. A great advantage lies in the alternative possible use of commercial ozonizers, thereby significantly lowering capital expenditure. The reactors of the invention are advantageously equipped with glass tubes, in particular with fused quartz tubes, wherein the tubes are preferably in parallel or coaxial arrangement and are spaced apart by means of spacers made of inert material. Suitable inert materials are in particular Teflon or glass. It is known that the injected electron energy for the plasma discharge “E” is dependent on the product (p-d) of pressure “p” and electrode separation “d”. For the process according to the present invention the product of electrode separation and pressure is generally in the range from 0.001 to 300 mm-bar, preferably from 0.05 to 100 mm-bar, particularly preferably 0.08 to 0.3 mm-bar, in particular 0.1 to 0.2 mm-bar. The discharge can be induced by means of various kinds of AC voltages or pulsed voltages from 1 to 10⁶ V. Similarly, the course of the voltage curve may be inter alia rectangular, trapezoidal, pulsed or an amalgam pieced together from individual time courses. Particularly suitable types are pulsed excitation voltages, which enable simultaneous formation of the discharge over the entire discharge space of the reactor. Pulse duration in pulsed operation depends on the gas system; it is preferably between 10 ns and 1 ms. Preferred voltage amplitudes are from 10 Vp to 100 kVp, preferably 100 Vp to 10 Vp, in particular 50 to 5 Vp, in a microsystem. The frequency of the AC voltage may be set between 10 MHz and 10 ns pulses (duty ratio 10:1) down to low frequencies in the range from 10 to 0.01 Hz. For example, an AC voltage having a frequency of 1.9 kHz and a peak-to-peak amplitude of 35 kV can be applied in the reactor. The power input is about 40 W.

The example which follows illustrates the process according to the invention in detail without limiting the invention to this example.

### EXAMPLE 1

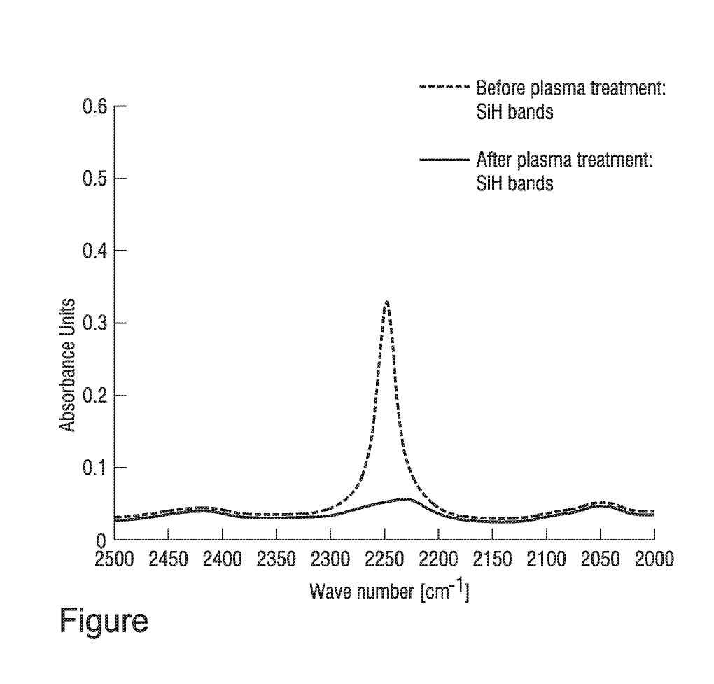

4 litres of an SiCl₄ contaminated with bromosilanes or bromohalosilanes as a consequence of production (FIG. 1) was transferred (by negative pressure) into the boiler of a distillation column. The SiCl₄ was freed of HCl and silanol at a reflux ratio of 1:10, see FIG. 1 (SiH bands of BrCl₂SiH before plasma treatment). The content of bromine is determined via the SiH bands (bromine content: 11.5 ppmw).

The distillation was effected discontinuously in a distillation apparatus comprising a 1.1 m column with a 30 mm Sulzer metal packing. At a bottoms temperature of about 57° C. and a pressure of 750 mbar_{abs} silicon tetrachloride is distilled off and collected at about −10° C. In the In-Process Control this distillate shows in the FT-IR spectrum clear proportions of brominated silanes, such as BrCl₂SiH, see FIG. 1 (SiH bands before plasma treatment).

The thus obtained distillate comprising silicon tetrachloride (SiCl₄) was continuously evaporated and passed into a nonthermal plasma in a gas discharge sector of a fused quartz reactor (plasma microreactor (gap about 1 mm)). The gas phase was passed through the reactor at about 250 ml/h. As the gas phase flowed through the glass plasma reactor an AC voltage having a frequency of 1.9 kHz and a peak to peak amplitude of 35 kV was applied. The power input into the reactor was about 40 W (primary power). The operating pressure was adjusted to about 350 mbar. The plasma reactor was operated as a closed-loop reactor. The obtained condensate was discharged into the boiler of the distillation column and distilled (same conditions as previously). The FT-IR spectrum of the distillate no longer contains the aforementioned impurities, see FIG. 1 (SiH bands after plasma treatment). The bromine-containing BrCl₂SiH compound is no longer detectable. Detection of the BrCl₂SiH is accomplished by determining the Si-H bands of the BrCl₂SiH in the IR spectrum and correspondingly converted to the content of bromine. The method of measurement is FT-IR with a path length of 1000 mm, STC at standard conditions (liquid, 20° C., 1 bar abs.).

It is thought that the plasma treatment forms Cl minus ions in the plasma which react with the brominated silane compounds and convert these into compounds easily removable by distillation from SiCl₄ by substituting the bromine.

Reactor geometry: Discharge sector: 10 cm, Annular slot radius: 0.6 cm Reactor diameter: 1.2 cm; Gap/slot width: 1 mm

### EXAMPLE 2

The example was performed analogously to example 1 with the exception that 9.7 ppmw of bromine-containing compound were obtained after the distillation. The distillate is subjected to a plasma treatment and subsequently distilled as described above. The thus obtained distillate has a content of bromine of less than 0.05 ppmw.

The invention is more particularly elucidated hereinbelow with reference to the working example depicted in the figure. It depicts:

FIG. 1: FT-IR spectrum with BrCl₂SiH before a plasma treatment and after the plasma treatment and redistillation. BrCl₂SiH was efficiently removed (not more than 0.05 ppmw of bromine).

1. A process for removal of bromine- or iodine-containing silicon compounds of general formula III
SiHal₄₋ₙHₙ (Ill)
from compositions of chlorosilanes, wherein the chlorosilanes comprise
at least one chlorosilane of general formula I
SiCl₄ (I),
polyperchlorosilanes of general formula II 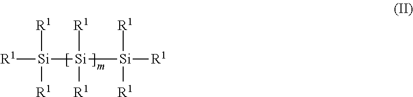
wherein R¹ is in each case chlorine and wherein m =0 to 100, and
branched polyperchlorosilanes and/or cyclic polyperchlorosilanes and/or mixtures thereof,
the process comprising:
(i) converting the composition of chlorosilanes into the gaseous state;
(ii) subjecting to a nonthermal plasma to obtain a converted composition of chlorosilanes;
(iii) distilling the converted composition of chlorosilanes; and
(iv) obtaining a composition of chlorosilanes having a reduced content of bromine, bromine- and/or iodine-containing silicon compounds,
wherein
the silicon tetrachloride of general formula I and/or hexadichlorosilane of formula II where n=0 is subjected to a nonthermal plasma, and
the bromine- and/or iodine-containing silicon compounds are halosilanes of general formula III
SiHal₄₋ₙHₐ (III),
wherein at least one Hal is selected from bromine and iodine and further Hal is independently selected from iodine where n=0, 1, 2 or 3.

2. The process according to claim 1,
wherein
the subjecting (ii) effects the nonthermal plasma treatment at a pressure of from 1 to 1000 mbar_{abs}.

3. The process according to claim 1,
wherein
the bromine- and/or iodine-containing silicon compounds are HSiCl₂Br or HSiClBr₂.

4. The process according to claim 1,
wherein
subjecting (ii) and optionally distilling (iii) are effected continuously.

5. The process according to claim 1,
wherein
the converted bromine- and/or iodine-containing silicon compounds in the distilling (iii) accumulate in a collection vessel of an apparatus for performing the process.

6. The process according to claim 1,
wherein
in (iii) the distillative workup is effected at a pressure between 1 to 1500 mbar_{abs}.

7. The process according to claim 1,
wherein
in (iii) the distillative workup of the converted composition is effected at tops temperatures in the range from 40° C. to 250° C.

8. The process according to claim 1,
wherein the plasma is a nonthermal plasma.

9. The process according to claim 1,
wherein
the composition in (iv) comprises not more than 1 ppmw of bromine and/or iodine.

10. The process according to claim 1,
wherein
nonthermal plasma is generated in a tubular reactor.

11. The process according to claim 8,
wherein
the plasma has a power density of 1 to 20 W/cm³.

12. The process according to claim 10,
wherein
nonthermal plasma is generated in a glass tubular reactor.

13. The process according to claim 10,
wherein
nonthermal plasma is generated in a fused quartz tubular reactor.
